(19) United States
(12) Patent Application Publication
(10) Pub. No.: US 2001/0037330 A1
(43) Pub. Date: Nov. 1, 2001

(54) Data input form retrieving system, data input form retrieving method, and computer-readable recording medium

(75) Inventors: Susumu Honma, Minato-ku (JP); Hidetoshi Osafune, Minato-ku (JP)

Correspondence Address: OLIFF & BERRIDGE, PLC, 277 S. WASHINGTON STREET, SUITE 500, ALEXANDRIA, VA, 22314, US

(73) Assignee: FUJI XEROX CO., LTD.

(21) Appl. No.: 09/836,386

(22) Filed: Apr. 18, 2001

(30) Foreign Application Priority Data
Apr. 20, 2000 (JP) 2000-119687

(51) Int. Cl. G06F 17/60; G06F 7/00; G06F 17/30

(52) U.S. Cl. 707/4; 707/3; 705/1

(57) ABSTRACT

A data input form retrieving system capable of easily finding a desired data input form is provided. A data input form retrieving system is provided with a storage unit for storing plural data input forms containing character strings, a character string extract unit for extracting character strings out of each of the plural data input forms stored in the storage unit, an extracting conditions input unit for inputting the conditions of extracting a specific data input form out of the plural data input forms, and a data input form extract unit for extracting the specific data input form by searching the character strings extracted by the character string extract unit in accordance with the extracting conditions inputted by the extracting conditions input unit.

### BACKGROUND OF THE INVENTION

1. Field of the Invention

The present invention relates to a data input form retrieving system for retrieving data input forms such as business forms, a data input form retrieving method and a computer-readable recording medium.

2. Description of the Related Art

It is very important to manage information in the information society in recent years. To manage such information, processes for inputting information and constructing a database of information are essential. Information is usually inputted using a data input form such as a business form. Thus, use of various data input forms according to the type of needed information makes possible inputting a wide variety of information and its integration into databases.

However, along with the diversification of information to be managed, data input forms are also becoming more and more diverse, and the number (variety) of such data input forms has become enormous. As a result, when a specific set of information is to be inputted, the data input form for inputting that specific set of information has to be found out from the enormous diversity of data input forms. This retrieval of the desired data input form has come to require tremendous time and labor along with the increase in the number of data input forms, and has become extremely difficult.

### SUMMARY OF THE INVENTION

The present invention, therefore, is intended to solve the problem noted above and provide a data input form retrieving system capable of easily retrieving a desired data input form, a data input form retrieving method and a computer-readable recording medium.

A data input form retrieving system according to the invention is provided with a character string extracting part for extracting character strings out of each of plural data input forms containing character strings, an extracting conditions input part for inputting conditions of extracting a specific data input form out of the plural data input forms, and a data input form extracting part for extracting the specific data input form by retrieving the character strings extracted by the character string extracting part in accordance with the extracting conditions inputted by the extracting conditions input part.

A data input form is often characterized by character strings contained in the data input form, including the title of the data input form and the names of information items to be inputted by using the data input form. Therefore, by extracting character strings out of each of the plural data input forms and extracting a specific data input form by retrieving the character strings in accordance with the inputted extracting conditions, the specific data Input form can be found with the character strings stated in the data input form being used as the clues.

Another data input form retrieving system includes a keyword adding part for adding a keyword to each of plural data input forms, an extracting condition input part for inputting a condition of extracting a specific data input form out of the plural data input forms, and a data input form extracting part for extracting the specific data input form by retrieving the keyword added by the keyword adding part in accordance with the extracting condition inputted by the extracting condition input part.

A data input form is often suggested by a keyword associated with an item of information inputted by using the data input form. Therefore, by adding a keyword to each of the plural data input forms and extracting a specific data input form by searching for the keyword in accordance with the inputted extracting conditions, the specific data input form can be found with the keyword added to the data input form being used as the clue.

Also to solve the problem noted above, a data input form retrieving method according to the invention is provided with a character string extracting step of extracting character strings out of each of plural data input forms containing character strings, an extracting conditions input step of inputting conditions of extracting a specific data input form out of the plural data input forms, and a data input form extracting step of extracting the specific data input form by retrieving the character strings extracted at the character string extracting step in accordance with the extracting conditions inputted at the extracting conditions input step.

Another data input form retrieving method according to the invention is provided with a keyword adding step of adding keywords to each of plural data input forms, an extracting conditions input step of inputting conditions of extracting a specific data input form out of the plural data input forms, and a data input form extracting step of extracting the specific data input form by retrieving the keywords added at the keyword adding step in accordance with the extracting conditions inputted at the extracting conditions input step.

Also to solve the problem noted above, a computer-readable recording medium according to the invention records thereon a program for causing a computer to execute a character string extracting step of extracting character strings out of each of plural data input forms containing character strings, an extracting conditions input step of inputting conditions of extracting a specific data input form out of the plural data input forms, and a data input form extracting step of extracting the specific data input form by retrieving the character strings extracted at the character string extracting step in accordance with the extracting conditions inputted at the extracting conditions input step.

Another computer-readable recording medium according to the invention records thereon a program for causing a computer to execute a keyword adding step of adding keywords to each of plural data input forms, an extracting conditions input step of inputting conditions of extracting a specific data input form out of the plural data input forms, and a data input form extracting step of extracting the specific data input form by searching the keywords added at the keyword adding step in accordance with the extracting conditions inputted at the extracting conditions input step.

### BRIEF DESCRIPTION OF THE DRAWINGS

Other features and advantages of the present invention will become more apparent from the detailed description of preferred embodiments thereof when taken in conjunction with the accompanying drawings, wherein:

FIG. 1 illustrates the configuration of a data input form retrieving system;

FIG. 2 illustrates the configuration of a data input form;

FIG. 3 illustrates the configurations of a data input form and a text file;

FIG. 4 is a flowchart showing the operation of the data input form retrieving system;

FIG. 5 illustrates the configurations of a data input form and a text file;

FIG. 6 illustrates the configuration of another data input form retrieving system;

FIG. 7 illustrates the configuration of a data input form to which a keyword is added;

FIG. 8 is a flowchart showing the operation of another data input form retrieving system;

FIG. 9 illustrates the configuration of a recording medium;

FIG. 10 illustrates the system configuration of a computer;

FIG. 11 shows a perspective view of the computer; and

FIG. 12 illustrates the configuration of another recording medium.

### DETAILED DESCRIPTION OF THE PREFERRED EMBODIMENTS

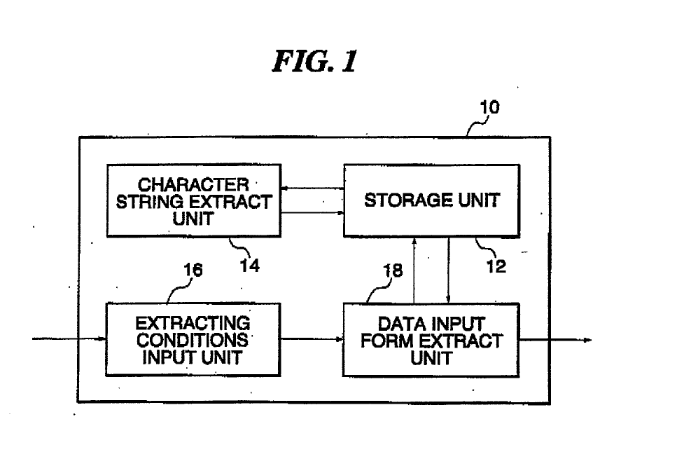

A data input form retrieving system which is a first preferred embodiment of the present invention, will be described below with reference to drawings. First will be described the data input form retrieving system embodying the invention in this mode. FIG. 1 illustrates the configuration of a data input form retrieving system, which is the first preferred embodiment of the invention.

A data input form retrieving system 10 embodying the invention in this mode, as Illustrated in FIG. 1, is provided with a storage unit 12, a character string extract unit 14, an extracting conditions input unit 16 and a data input form extract unit 18. Each constituent element will be described in detail below.

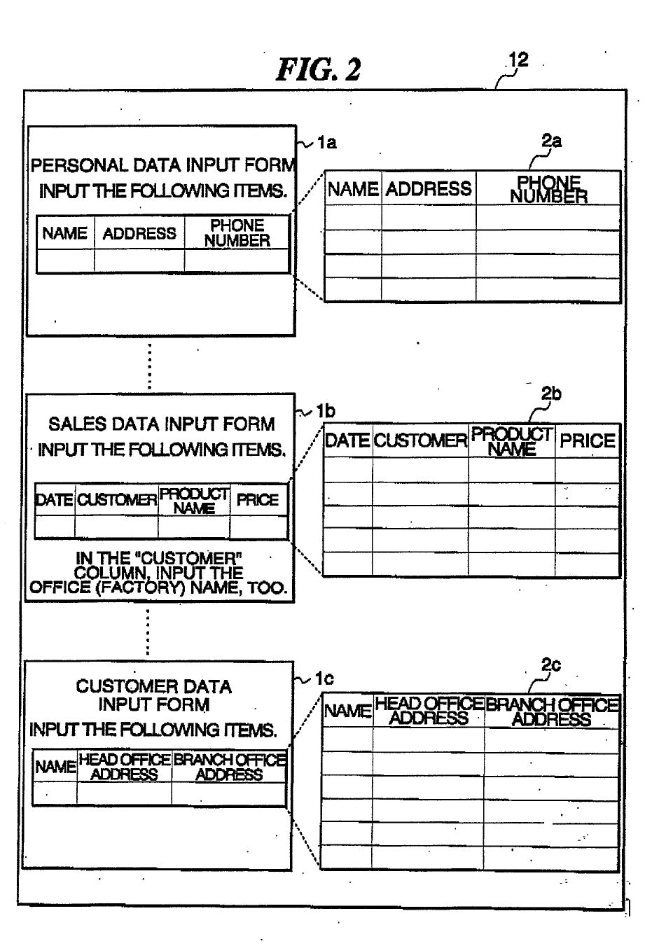

The storage unit 12 stores plural (e.g. hundreds to thousands) data input forms. In more detail, the storage unit 12 stores, as shown in FIG. 2 for instance, a personal data input form 1a, a sales data input form 1b, a customer data input form 1c and the like.

The configuration of each of such data input forms includes character strings containing the title of the data input form, the names of information items to be inputted by using the data input form data input form and a point or points to be noted when inputting information by using the data input form. The configuration of, for instance, a personal data input form 1a shown in FIG. 2 includes such character strings as “personal data input form” as the title of the data input form, “name”, “address” and “phone number” as the names of information items to be Inputted by using the data input form, and “input the following items” as a point to be noted when inputting information by using the data input form. The configuration of a sales data input form 1b shown in FIG. 2 includes such character strings as “sales data input form” as the title of the data input form, “date”, “customer”, “product name” and “price” as the names of information items to be inputted by using the data input form, and “input the following items” and “in the ‘customer’ column, input the office (factory) name, too” as points to be noted when inputting information by using the data input form. The configuration of a customer data input form 1c shown in FIG. 2 includes such character strings as “customer data Input form” as the title of the data input form, “name”, “head office address” and “branch office address” as the names of information items to be inputted by using the data input form, and “input the following items” as a point to be noted when inputting information by using the data input form.

In each of these data input forms, the blanks to be filled with data make up a table in which the names of information items to be inputted are indicated in the cells of the first row. This table is associated with a database in which the field names are the names of information items to be inputted. Therefore, when data is inputted into the data input form, the data is at the same time inputted into the respectively corresponding fields of the matching database. For instance, the personal data input form la shown in FIG. 2 has a table having “name”, “address” and “phone number” cells on the first row as columns into which data is to be inputted. This table is associated with a database 2a having “name”, “address” and “phone number” as its field names. Therefore, when name, address and phone number data pieces are inputted into the table of the personal data input form 1a, these data pieces are at the same time inputted into the respectively corresponding fields of the matching database 2a. The sales data input form 1b shown in FIG. 2 has a table having “date”, “customer”, “product name” and “price” cells on the first row as columns into which data is to be inputted. This table is associated with a database 2b having “date”, “customer”, “product name” and “price” as its field names. Therefore, when customer, product name and price data pieces are inputted into the table of the sales data input form 1b, these data pieces are at the same time inputted into the respectively corresponding fields of the matching database 2b. The customer data input form 1c shown in FIG. 2 has a table having “name”, “head office address” and “branch office address” cells on the first row as columns into which data is to be inputted. This table is associated with a database 2c having “name”, “head office address” and “branch office address” as its field names. Therefore, when name, data pieces of head office address and branch office address are inputted into the table of the customer data input form 1c, these data pieces are at the same time inputted into the respectively corresponding fields of the matching database 2c.

The character string extract unit 14 extracts character strings from each of plural data input forms made up of character strings. In more details the character string extract unit 14 first reads each of plural data input forms stored In the storage unit 12. The character string extract unit 14 extracts all the character strings contained in the data input forms that it has read out. Thus the character string extract unit 14 extracts all the character strings contained in each such data input form, including the title of the data input form, the names of information items to be inputted by using the data input form data input form and a point or points to be noted when inputting information by using the data input form. The character strings to be extracted here also include character data contained in-the cells of the table. The character string extract unit 14 includes, with respect to each of plural data input forms, a text file containing all the character strings extracted from the data-input form.

The storage unit 12 stores the text file made up by the character string extract unit 14 in association with the data input form.

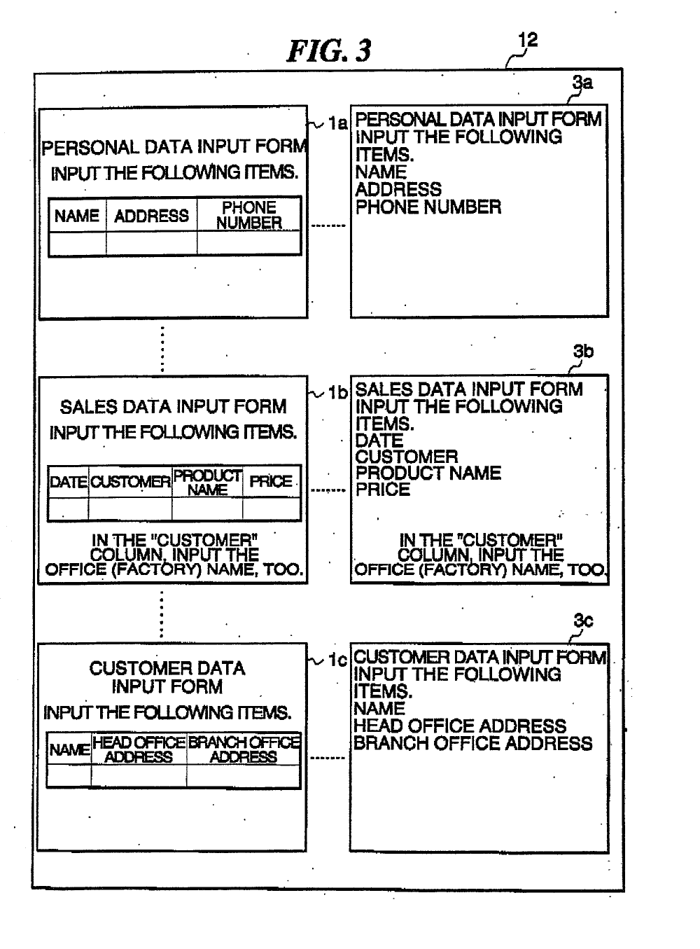

For instance, the character string extract unit 14, as shown in FIG. 3, extracts all the character strings contained in the personal data input form 1a, including the “personal data input form”, “input the following items”, “name”, “address” and “phone number”, and includes a text file 3a containing all the character strings it has extracted. The storage unit 12 stores the text file 3a made up by the character string extract unit 14 in association with the matching personal data input form 1a. The character string extract unit 14, as shown in FIG. 3, also extracts all the character strings contained in the sales data input form 1b, i.e. “sales data input form”, “input the following items”, “date”, “customer” and “product name”, “price” and “in the ‘customer’ column, input the office (factory) name, too” to include a text file 3b containing all the extracted character strings, The storage unit 12 stores the text file 3b made up by the character string extract unit 14 in association with the matching sales data input form lb. The character string extract unit 14, as shown in FIG. 3, also extracts all the character strings contained in the customer data input form 1c, i,e. “customer data input form”, “input the following items”, “name”, “head office address” and “branch office address” to include a text file 3c containing all the extracted character strings. The storage unit 12 stores the text file 3c made up by the character string extract unit 14 in association with the matching customer data input form 1c.

The extracting conditions input unit 16 inputs extracting conditions for extracting a specific data input form out of plural data input forms. More specifically, the extracting conditions input unit 16 accepts the input of specific character strings such as “personal data” and “address”. In this case, “including a character string of ‘personal data’”, “including a character string of ‘address’” and the like are the extracting conditions. The extracting conditions input unit 16 is designed to be able to input more complex extracting conditions including AND conditions such as “including a character string of ‘personal data’ and also including a character string of ‘address’” and OR conditions such as “including a character string of ‘personal data’ or including a character string of ‘address’”.

The data input form extract unit 18 extracts a specific data input form by searching the character strings extracted by the character string extract unit 14 in accordance with the extracting conditions inputted by the extracting conditions input unit 16. In more detail, the data input form extract unit 18 searches plural text files made up by the character string extract unit 14 and stored in the storage unit 12 in accordance with the extracting conditions inputted by the extracting conditions input unit 16, and extracts the specific data input form satisfying the extracting conditions. For instance, if the extracting conditions input unit 16 inputs an extracting condition of “including a character string of ‘personal data’”, the data input form extract unit 18 searches the plural text files, extracts the text file 3a which contains a character string of “personal data”, and also extracts the personal data input form 1a matching the text file 3a (see FIG. 3). The data input form extract unit 18 also displays the extracted data input form on a display not shown.

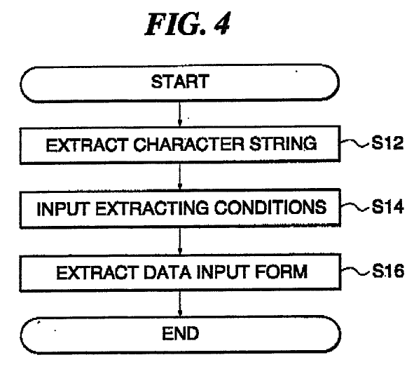

Next will be described the operation of the data input form retrieving system embodying the invention as described above together with a data input form retrieving method similarly embodying the invention. FIG. 4 is a flowchart showing the operation of the data Input form retrieving system, which is the first preferred embodiment of the invention.

Before starting to search data input forms by using the data input form retrieving system 10, first, as shown in FIG. 4, character strings are extracted by the character string extract unit 14 from each of the plural data input forms containing character strings (S12). In more detail, first, each of the plural data input forms stored in the storage unit 12 is read out. Then, all the character strings contained in the data input forms that have been read out are extracted. Thus, from each data input form, all the character strings contained in the data input form, including the title of the data input form, the names of information items to be inputted by using the data input form data input form and a point or points to be noted when inputting information by using the data input form, are extracted. The character strings to be extracted here also include character data contained in the cells of the table. When all the character strings have been extracted from each of the plural data input forms, with respect to each of plural data input forms, a text file containing all the character strings extracted from the data input form is made up. The text files made up here are stored into the storage unit 12 in association with the data input form.

For the personal data input form 1a shown in FIG. 3 for instance, all the character strings contained in the personal data input form 1a, i.e. “personal data input form”, “input the following items”, “name”, “address” and “Phone number” are extracted, and the text file 3a containing all the extracted character strings is made up. The text file 3a so made up is stored into the storage unit 12 in association with the matching personal data input form 1a. For the sales data input form 1b also shown in FIGS. 3, all the character strings contained in the sales data input form 1b, i.e. “sales data input form”, “input the following items”, “date”, “customer”, “product name,” “price” and “in the ‘customer’ column, input the office (factory) name, too” are extracted, and the text file 3b containing all the extracted character strings is made up. The text file 3b so made up is stored into the storage unit 12 in association with the matching sales data input form 1b. For the customer data input form 1c further shown in FIG. 3, all the character strings contained in the customer data input form 1c, i.e. “customer data input form”, “input the following items”, “name”, “head office address” and “branch office address” are extracted, and the text file 3c containing all the extracted character strings is made up. The text file 3c so made up is stored into the storage unit 12 in association with the matching customer data input form 1c.

When actually data input forms arc to be searched using the data input form retrieving system 10, the user inputs into the extracting conditions input unit 16 extracting conditions for extracting a specific data input form out of the plural data input forms (S 14). In more specific terms, the user inputs specific character strings including “personal data” and “address” into the extracting conditions input unit 16. In this case, the character strings such as “including a character string of ‘personal data’” and “including a character string of ‘address’” are the extracting conditions. The user can also input into the extracting conditions input unit 16 more complex extracting conditions including AND conditions such as “including a character string of ‘personal data’ and also including a character string of ‘address’” and OR conditions such as “including a character string of ‘personal data’ or including a character string of ‘address’”.

Upon inputting the extracting conditions, the data input form extract unit 18 searches, in accordance with the extracting conditions inputted by the extracting conditions input unit 16, the character strings extracted by the character string extract unit 14, and extracts a specific data input form (S16). In more detail, in accordance with the extracting conditions inputted by the extracting conditions input unit 16, the plural text files made up by the character string extract unit 14 and stored in the storage unit 12 are searched, and a specific data input form satisfying the extracting conditions is extracted. If the extracting conditions input unit 16 has inputted an extracting condition of “including a character string of ‘personal data’”, then the plural text files are searched, the text file 3a containing the character string of “personal data” is extracted, and the personal data input form 1a matching the text file 3a is extracted (see FIG. 3). The extracted data input form is displayed on a display not shown.

Now will be described the actions and benefits of the data input form retrieving system embodying the invention as described above. A data input form is often characterized by character strings contained in the data input form, including the title of the data input form and the names of information items to be inputted by using the data input form. The data input form retrieving system 10, which is the first preferred embodiment of the invention, extracts with its character string extract unit 14 in advance character strings out of each of plural data input forms, and extracts a specific data input form by searching the character strings with its data input form extract unit 18 in accordance with the extracting conditions inputted by the extracting conditions input unit 16. Therefore, the specific data input form can be found with a character string stated in the data input form as the clue. As a result, the desired data input form can be easily located.

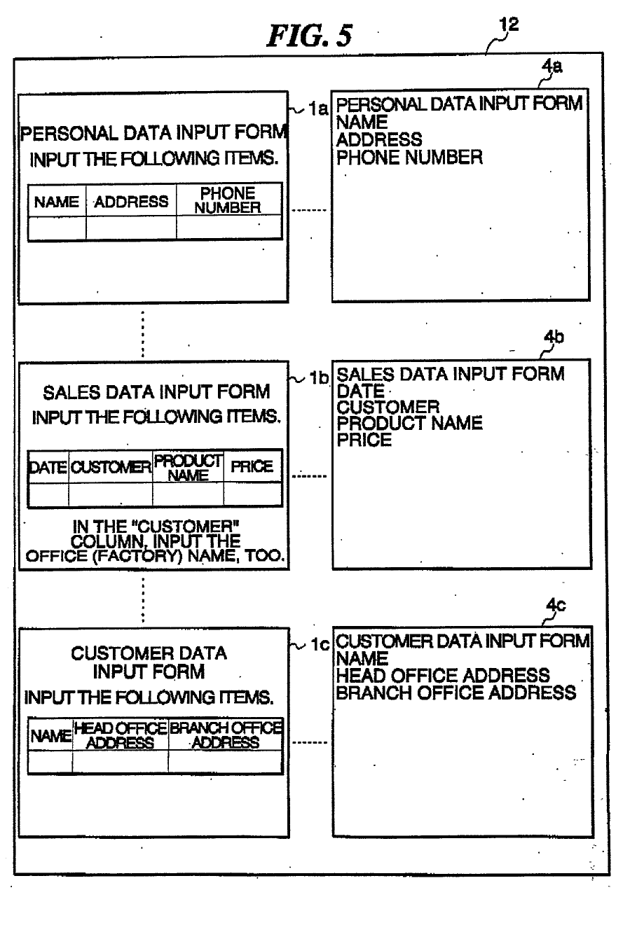

Also, the data input form retrieving system 10 embodying the invention as described above extracts with its character string extract unit 14 all the character strings contained in each of the plural data input forms, and makes up a text file containing all the extracted character strings. The data input form retrieving system 10, which is the first preferred embodiment of the invention, further searches a text file or files containing all the character strings contained in the data input form with its data input form extract unit 18. Therefore, the range of searching by the data input form extract unit 18 can be expanded, resulting in an extremely high level of searching precision. While the data input form retrieving system 10 embodying the invention as described above extracts with its character sting extract unit 14 all the character strings contained each of the plural data input forms, and searches with its data input form extract unit 18 all the character strings contained in each data input form, it is also acceptable to extract with the character string extract unit 14 specific character strings (so-called indices) selected out of the character strings contained in each of the plural data input forms, and to search the selected specific character strings with the data input form extract unit 18. In this case, the character string extract unit 14, as shown in FIG. 5, selects a specific character string or strings out of each data input form, and extracts the selected specific character string or strings. The character string extract unit 14 also makes up, for each of the plural data input forms, a text file containing the character strings extracted from the data input form. The selection of a specific character string or strings here can be performed under one of a number of conceivable rules, such as selecting only nouns or only non-sentence parts. The storage unit 12 stores the text file made up by the character string extract unit 14 in association with the matching data input form.

For instance, if character strings are selected under the rule of nonsentence pans only, the character string extract unit 14 will selectively extract the character strings of “personal data input form”, “name”, “address” and “phone number” out of the character strings contained in the personal data input form 1a, and makes up a text file 4a containing the extracted character strings. The storage unit 12 stores the text file 4a made up by the character string extract unit 14 in association with the matching personal data input form 1a. The character string extract unit 14, as shown in FIG. 5, also selectively extracts the character strings of “sales data input form”, “date”, “customer”, “product name” and “price” out of the character strings contained in the sales data input form 1b, and Includes a text file 4b containing the extracted character string. The storage unit 12 stores the text file 4b made up by the character string extract unit 14 in association with the matching sales data input form 1b. The character string extract unit 14, as shown in FIG. 3, also selectively extracts the character strings “customer data input form”, “name”, “head office address” and “branch office address” out of the character strings contained in the customer data input form 1c, and makes up a text file 4c containing the extracted character strings. The storage unit 12 stores the text file 4c made up by the character string extract unit 14 in association with the matching customer data input form 1e.

By extracting with the character string extract unit 14 in advance a selected specific character string or strings out of character strings contained in the plural data input forms, and using the selected specific character string or strings for searching by the data input form extract unit 18, the range of searching by the data input form extract unit 18 can be narrowed down. As a result, the time taken by the data input form extract unit 18 for searching can be reduced.

Now will be described a data input form retrieving system, which is a second preferred embodiment of the present invention, with reference to drawings. The data input form retrieving system embodying the invention in this manner differs from the above-described first embodiment, which is the data input retrieving system 10, in that while the data input form retrieving system 10 extracts a specific data input form by extracting character strings out of each of plural data input form and searching the extracted character strings, the data input form retrieving system embodying the invention in this second mode extracts a specific data input form by adding a keyword or keywords to each of plural data input forms and searching the keywords.

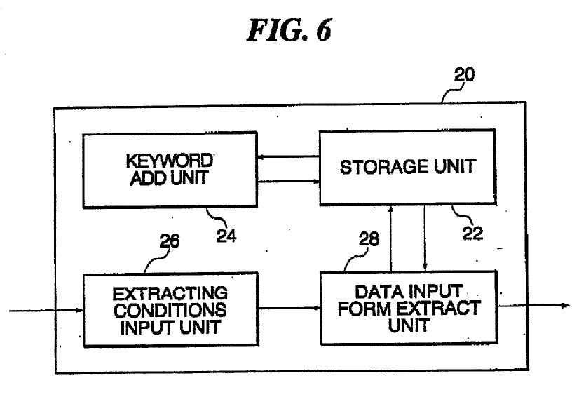

First will be described the configuration of the data input form retrieving system embodying the invention in this second mode. FIG. 6 illustrates the configuration of the data input form retrieving system, which is this second preferred embodiment of the invention.

The data input form retrieving system 20 embodying the invention in this mode, as shown in FIG. 6, is provided with a storage unit 22, a keyword adding unit 24 (keyword adding part), an extracting conditions input unit 26 (extracting conditions input part) and a data input form extract unit 28 (data input form extracting part). Each constituent element will be described in detail below.

The storage unit 22, like the storage unit 12 in the previously described first preferred embodiment, stores plural data input forms including, for instance, the personal data input form 1a, the sales data input form 1b and the customer data input form 1c shown in FIG. 2. The keyword adding unit 24 adds a keyword or keywords to each of the plural data input forms. In more detail, the keyword adding unit 24 adds a keyword inputted by the user having referenced the data input forms or a keyword automatically generated by natural language analysis or otherwise to each of the plural data input forms. The keyword adding unit 24 may add either one word to one data input form or plural keywords to one data input form.

The storage unit 22 stores the keywords added by the keyword adding unit 24 in association with the respectively matching data input forms.

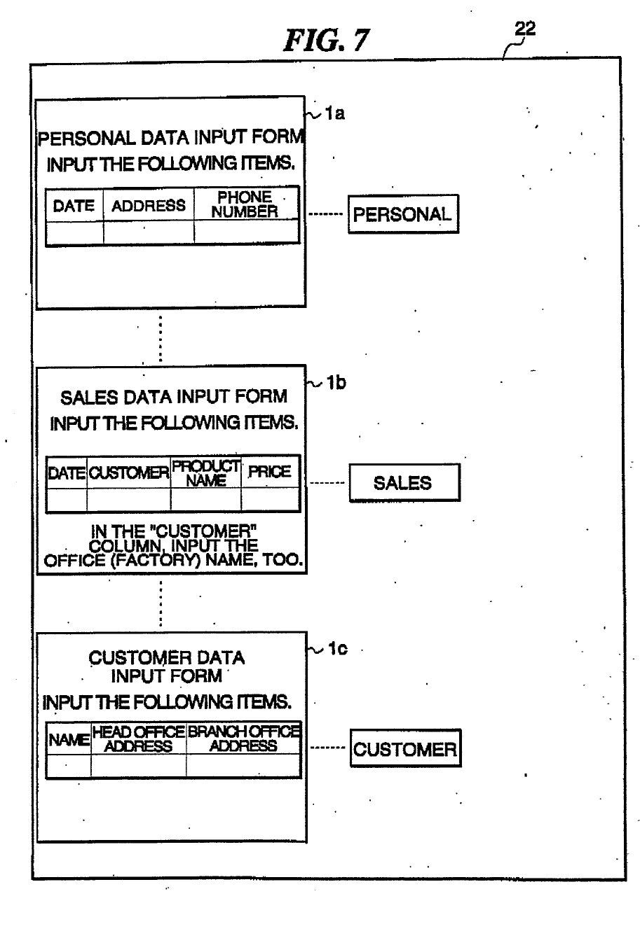

More specifically the keyword adding unit 24, as shown in FIG. 7 for instance, adds a keyword of “personal” for the personal data input form 1a, one of “sales” for the sales data input form 1b and one of “customer” for the customer data input form 1c, and the storage unit 22 stores the keywords added by the keyword adding unit 24 in association with the respectively matching data input forms.

The extracting conditions input unit 26, like the extracting conditions input unit 16 in the previously described first preferred embodiment, inputs extracting conditions for extracting a specific data input form out of plural data input forms.

The data input form extract unit 28 extracts the specific data input form by searching keywords added by the keyword adding unit 24 in accordance with the extracting conditions inputted by the extracting conditions input unit 26. For instance, if the extracting conditions input unit 26 inputs an extracting condition “keyword ‘personal’ being added”, the data input form extract unit 28 searches keywords added to the plural data input forms, extracts a keyword “personal”, and also extracts the personal data input form 1a to which the keyword is added (see FIG. 7). The data input form extract unit 28 displays the extracted data input form on a display not shown.

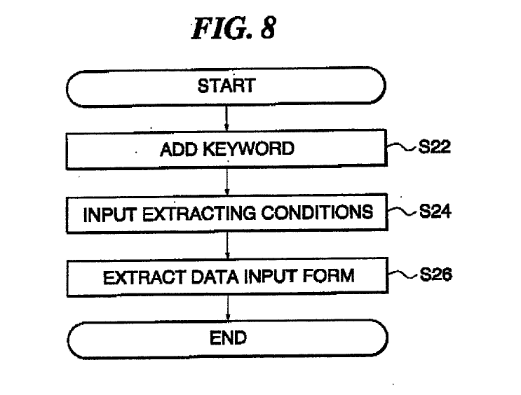

Next will be described the operation of the data input form retrieving system embodying the invention in this second mode together with a data input form retrieving method similarly embodying the invention. FIG. 8 is a flowchart showing the operation of the data input form retrieving system, which is the second preferred embodiment of the invention.

Before starting to search data input forms by using the data input form retrieving system 20, first, as shown in FIG. 8B a keyword or keywords are added by the keyword adding unit 24 to each of the plural data input forms (S22). In more detail, the keyword adding unit 24 adds a keyword inputted by the user having referenced the data input forms or a keyword automatically generated by natural language analysis or otherwise to each of the plural data input forms. The storage unit 22 stores the keywords added by the keyword adding unit 24 in association with the respectively matching data input forms.

More specifically, as shown in FIG. 7 for instance, a keyword of “personal” for the personal data input form 1a, one of “sales” for the sales data input form 1b and one of “customer” for the customer data input form 1e are added, and they are stored into the storage unit 22 in association with the respectively matching data input forms.

When actually data input forms are to be searched using the data input form retrieving system 20, the user inputs into the extracting conditions input unit 26 extracting conditions for extracting a specific data input form out of the plural data input forms (S24).

Upon inputting the extracting conditions, the data input form extract unit 28 searches, in accordance with the extracting conditions inputted by the extracting conditions input unit 26, the keywords added by the keyword adding unit 24, and extracts a specific data input form (S26). If, for instance, the extracting conditions input unit 26 has inputted an extracting condition of “keyword ‘personal’ being added”, then the plural data input forms are searched for the keyword added to each of them, the keyword “personal” is extracted, and the personal data input form 1a to which the keyword is added is extracted (see FIG. 7). The ‘extracted’ data input form is displayed on a display not shown.

Now will be described the actions and benefits of the data input form retrieving system embodying the invention in the second mode. A data input form is often suggested by a keyword associated with an item of information inputted by using the data input form. The data input form retrieving system 20, which is the second preferred embodiment of the invention, adds with its keyword adding unit 24 in advance a keyword to each of the plural data input forms and extracts a specific data input form by searching the keywords with its data input form extract unit 28 in accordance with the extracting conditions inputted by the extracting conditions input unit 26. Therefore, the specific data input form can be found with the keyword added to the data input form being used as the clue. As a result, the desired data input form can be easily located.

Next will be described a computer-readable recording medium pertaining to the first preferred embodiment of the present invention (hereinafter to be referred to as simply the recording medium). The recording medium here is what is capable of inducing a varying state of energy, such as magnetism, light, electricity, in a reader provided in a hardware resource of a computer according to the stated contents of a program, and communicating the stated contents of the program to the reader in a matching signal form. Such a recording medium may be, for instance, a magnetic disk, an optical disk, a CD-ROM or a memory built into a computer.

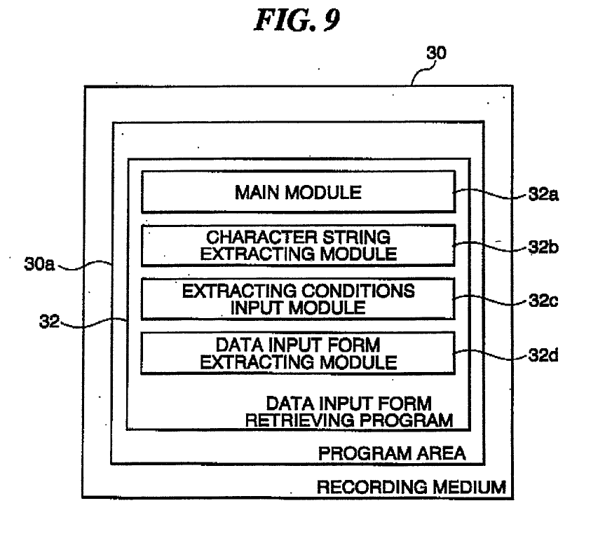

FIG. 9 illustrates the configuration of the recording medium pertaining to the first preferred embodiment of the invention. A recording medium 30, as shown in FIG. 9, is provided with a program area 30a for recording programs, and in this program area 30a is recorded a data input form retrieving program 32. The data input form retrieving program 32 has a main module 32a for exercising overall control of processing, a character string extracting module 32b for extracting a character string or strings from each of plural data input forms containing character strings, an extracting conditions input module 32c for inputting extracting conditions for extracting a specific data input form out of plural data input forms, and a data input form extracting module 32d for extracting a specific data input form by searching character strings extracted by operating the character string extracting module 32b in accordance with extracting conditions inputted by operating the extracting conditions input module 32c. The functions implemented here by operating the character string extracting module 32b, the extracting conditions input module 32c and the data input form extracting module 32d are the same as the respective functions of the character string extract unit 14, the extracting conditions input unit 16 and the data input form extract unit 18 of the data input form retrieving system 10.

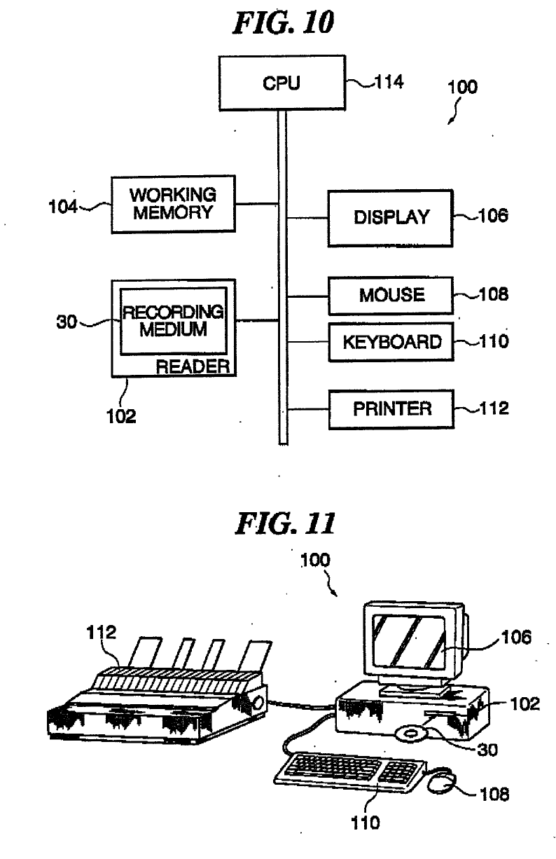

FIG. 10 illustrates the system configuration of a computer for executing the data input form retrieving program 32 recorded on the recording medium 30, and FIG. 11 shows a perspective view of the computer for executing the data input form retrieving program 32 recorded on the recording medium 30. A computer 100, as shown in FIGS. 10 and 11, is provided with a reader 102, a working memory (RAM)104 in which an operating system (OS) is stationed permanently, a display 106 as a displaying part, a mouse 108 and a keyboard 110 as an input part, a printer 112 for printing data input forms and the like, and a CPU 114 for controlling the execution of the data input form retrieving program 32 among other functions. Hereupon, when the recording medium 30 is inserted into the reader 102, information recorded on the recording medium 30 becomes accessible from the reader 102, and the data input form retrieving program 32 recorded in the program area 30a of the recording medium 30 becomes executable by the computer 100.

As the reader 102, a flexible disk drive unit, a CD-ROM drive unit, or a magnetic tape drive unit may be used according to the type of the recording medium 30.

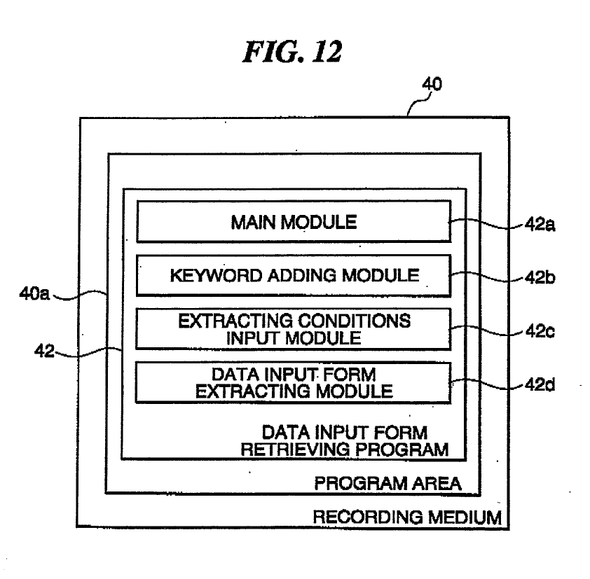

Next will be described the computer-readable recording medium pertaining to the second preferred embodiment of the present invention (hereinafter to be referred to as simply the recording medium). FIG. 12 illustrates the configuration of the recording medium pertaining to the second preferred embodiment of the invention. A recording medium 40, as shown in FIG. 12, is provided with a program area 40a for recording programs, and in this program area 40a is recorded a data input form retrieving program 42. The data input form retrieving program 42 has a main module 42a for overall control processing, a keyword adding module 42b for adding a keyword or keywords to each of plural data input forms, an extracting conditions input module 42c for inputting extracting conditions for extracting a specific data input form out of plural data input forms, and a data input form extracting module 42d for extracting a specific data input form by searching keywords added by operating the keyword adding module 42b in accordance with extracting conditions inputted by operating the extracting conditions input module 42c. The functions implemented here by operating the keyword adding module 42b, the extracting conditions input module 42c and the data input form extracting module 42d are the same as the respective functions of the keyword adding unit 24, the extracting conditions input unit 26 and the data input form extract unit 28 of the data input form retrieving system 20.

Hereupon, when the recording medium 40 is inserted into the reader 102 illustrated in FIGS. 10 and 11, information recorded on the recording medium 40 becomes accessible from the reader 102, and the data input form retrieving program 42 recorded in the program area 40a of the recording medium 40 becomes executable by the computer 100.

A data input form is often characterized by character strings contained in the data input form, including the title of the data input form and the names of information items to be inputted by using the data input form. The data input form retrieving system, the data input form retrieving method and the computer-readable recording medium according to the invention extract in advance character strings out of each of plural data input forms, and extract a specific data input form by searching the character strings in accordance with the extracting conditions that are inputted. Therefore, the specific data input form can be found with a character string stated in the data input form as the clue. As a result, the desired data input form can be easily located.

The data input form retrieving system, the data input form retrieving method and the computer-readable recording medium according to the invention can expand the range of searching by extracting in advance all the character strings contained in each of the plural data input forms and searching all the character strings, resulting in an extremely high level of searching precision.

Alternatively, the data input form retrieving system, the data input form retrieving method and the computer-readable recording medium according to the invention can narrow down the range of searching by extracting in advance a selected specific character string or strings out of character strings contained in each of the plural data input forms, and using the selected specific character string or strings for searching with the result that the time taken for searching can be reduced.

A data input form is often suggested by a keyword associated with an item of information inputted by using the data input form. The data input form retrieving system, the data input form retrieving method and the computer-readable recording medium according to the invention, by adding a keyword to each of the plural data input forms and extracting a specific data input form by searching the keyword in accordance with inputted extracting conditions, can find the specific data input form by using the keyword added to the data input form as the clue. As a result, the desired data input form can be easily located.

The entire disclosure of Japanese Patent Application No. 2000-119687 filed on Apr. 20, 2000 including specification, claims, drawings and abstract is incorporated herein by reference in its entirety.

What is claimed is:

1. A data input form retrieving system comprising;
character string extracting means for extracting a character string out of each of plural data input forms containing character strings;
extracting conditions input means for inputting a condition of extracting a specific data input form out of the plural data input forms; and
data input form extracting means for extracting the specific data input form by retrieving the character string extracted by the character string extracting means in accordance with the extracting condition inputted by the extracting condition input means.

2. The data input form retrieving system according to claim 1, wherein all the character strings contained in each of the plural data input forms are extracted.

3. The data input form retrieving system according to claim 1, wherein a specific character string is selected out of the character strings contained in the plural data input forms.

4. A data input form retrieving system comprising:
keyword adding means for adding a keyword to each of plural data input forms;
extracting condition input means for inputting a condition of extracting a specific data input form out of the plural data input forms; and
data input form extracting means for extracting the specific data input form by retrieving the keyword added by the keyword adding means in accordance with the extracting condition inputted by the extracting condition input means.

5. A data input form retrieving method comprising:
extracting a character string out of each of plural data input forms containing character strings;
inputting a condition of extracting a specific data input form out of the plural data input forms; and
extracting the specific data input form by retrieving the extracted character string in accordance with the inputted extracting condition.

6. The data input form retrieving method according to claim 5, wherein all the character strings contained in each of the plural data input forms are extracted.

7. The data input form retrieving method according to claim 5, wherein a specific character string is selected out of the character strings contained in the plural data input forms.

8. A data input form retrieving method comprising:
adding a keyword to each of plural data input forms;
inputting a condition of extracting a specific data input form out of the plural data input forms; and
extracting the specific data input form by retrieving the added keyword in accordance with the inputted extracting condition.

9. A computer-readable recording medium recording thereon a program for causing a computer to execute the steps of:
extracting a character out of each of plural data input forms containing character strings;
inputting a condition of extracting a specific data input form out of the plural data input forms; and
extracting the specific data input form by retrieving the extracted character string in accordance with the inputted extracting condition.

10. The computer-readable recording medium according to claim 9, wherein all the character strings contained in each of the plural data input forms are extracted.

11. The computer-reading medium according to claim 9, wherein a specific character string is selected out of the character strings contained in the plural data input forms.

12. A computer-readable recording medium recording thereon a program for causing a computer to execute the steps of:
adding a keyword to each plural data input forms;
inputting a condition of extracting a specific data input form out of the plural data input forms; and
extracting the specific data input form by retrieving the added keyword in accordance with the inputted extracting condition.
